(19) United States
(12) Patent Application Publication
(10) Pub. No.: US 2026/0220426 A1
(43) Pub. Date: Jul. 30, 2026

(54) AGENT CREATION, DEPLOYMENT, AND MANAGEMENT IN A MULTI-AGENT SYSTEM WITH LLM-BASED AGENTS

(71) Applicant: Cisco Technology, Inc., San Jose, CA (US)

(72) Inventors: Advit Deepak, San Jose, CA (US); Jayanth Srinivasa, Newark, CA (US); Myungjin Lee, Bellevue, WA (US); Hugo Latapie, Temecula, CA (US); Ramana Rao V.R. Kompella, Foster City, CA (US)

(73) Assignee: Cisco Technology, Inc., San Jose, CA (US)

(21) Appl. No.: 19/037,658

(22) Filed: Jan. 27, 2025

(51) Int. Cl. G06N 3/045

(52) U.S. Cl. CPC G06N 3/045

(57) ABSTRACT

In one implementation, a device identifies capabilities of agents in a multi-agent system in which each agent uses a corresponding artificial intelligence model to perform sub-tasks of a task performed by the multi-agent system. The device obtains metrics regarding interactions between the agents. The device determines a change to the multi-agent system, based on the capabilities and metrics. The device provides an indication of the change to a user interface.

### TECHNICAL FIELD

The present disclosure relates generally to agent creation, deployment, and management in a multi-agent system with large language model (LLM)-based agents.

### BACKGROUND

The recent breakthroughs in large language models (LLMs) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

Today, systems that use multiple such agents are static in nature, with fixed system prompts for each agent and unchanging routing protocols between agents. This often results in redundancy and a lack of continuous improvement. Hardcoded state graphs and action protocols result in wasted resources on agents, as certain agents and/or prompts may not contribute significantly to the multi-agent system's task. Furthermore, users often are unaware of what configuration of agents will be best suited to solve a task.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example architecture for a multi-agent system;

FIG. 6 illustrates an example dashboard to manage a multi-agent system;

FIG. 7 illustrates an example optimization of the multi-agent system of FIG. 5;

FIG. 8 illustrates an example of model pruning to optimize the model of an AI agent;

FIG. 9 illustrates an example of the deployment of a new agent to a multi-agent system; and

FIG. 10 illustrates an example of a simplified procedure for assessing the interactions of AI agents, in accordance with one or more implementations described herein.

### DESCRIPTION OF EXAMPLE IMPLEMENTATIONS

### Overview

According to one or more implementations of the disclosure, a device identifies capabilities of agents in a multi-agent system in which each agent uses a corresponding artificial intelligence model to perform sub-tasks of a task performed by the multi-agent system. The device obtains metrics regarding interactions between the agents. The device determines a change to the multi-agent system, based on the capabilities and metrics. The device provides an indication of the change to a user interface.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

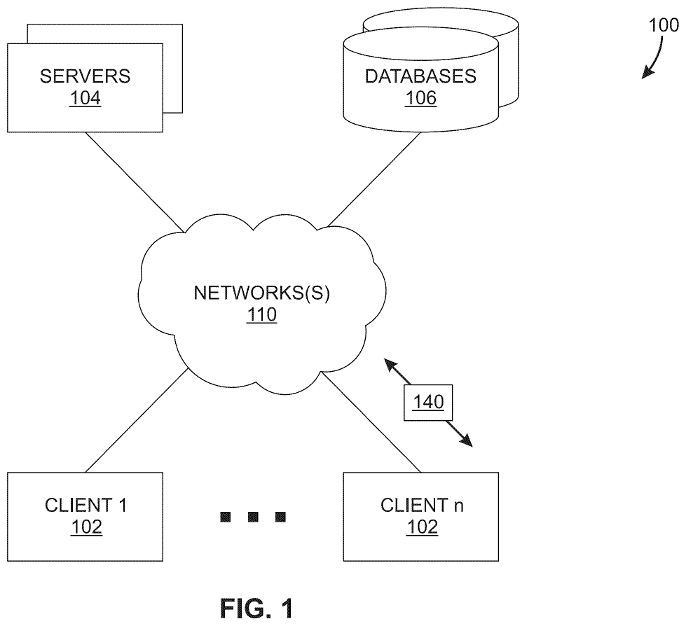

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

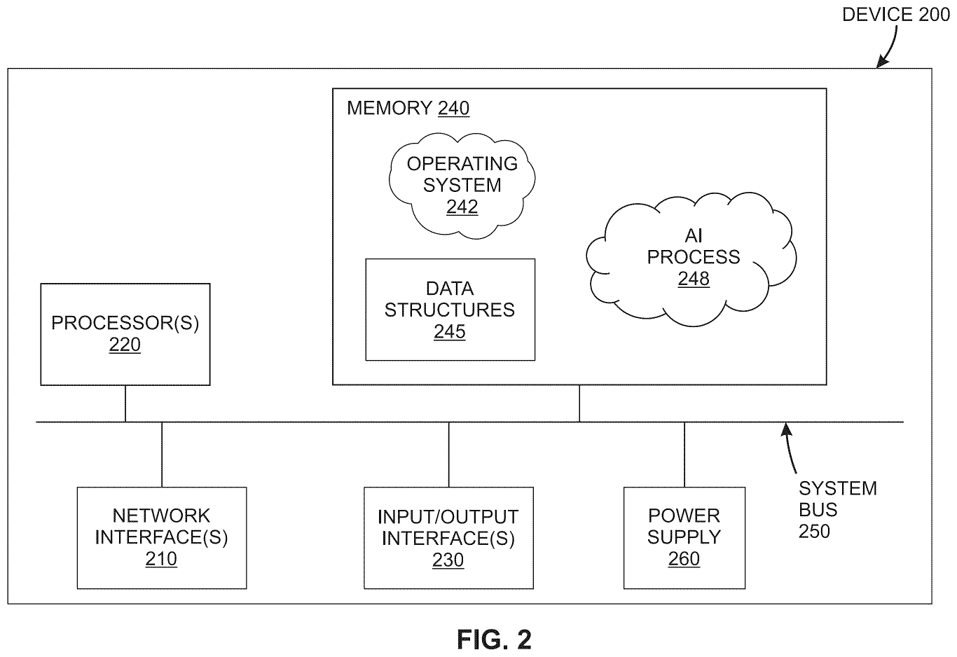

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 may use include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may use a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

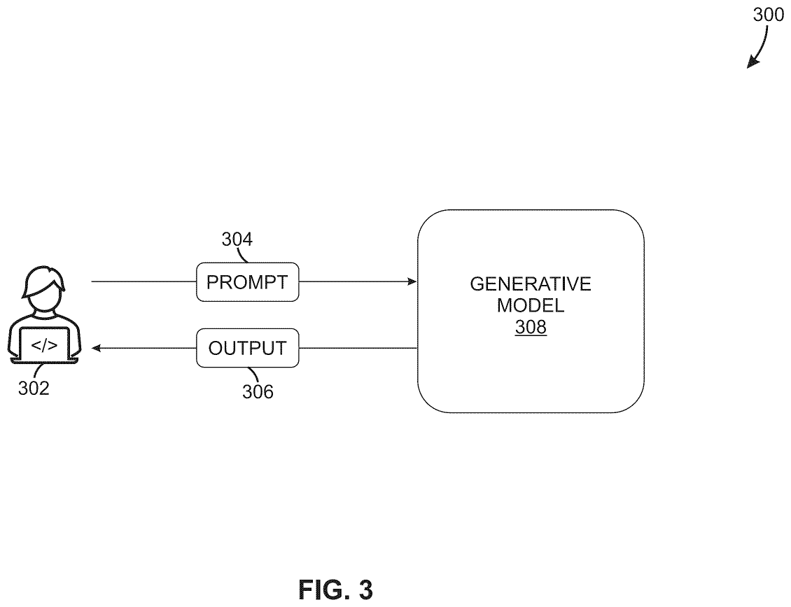

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As would be appreciated, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

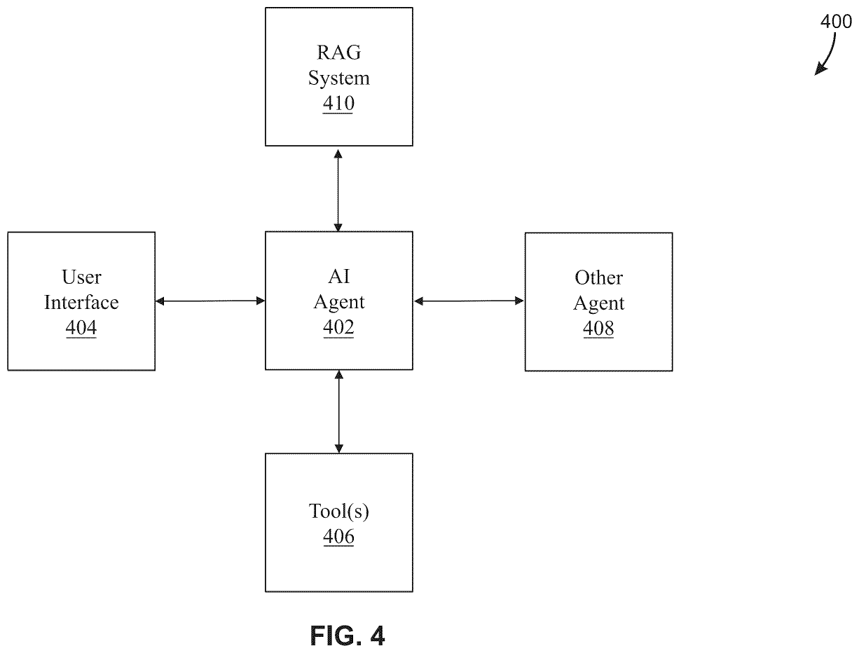

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, multi-agent systems that use AI agents, such as AI agent 402, are static in nature. Indeed, such systems typically use fixed system prompts for each agent and unchanging routing protocols between agents. This often results in redundancy and a lack of continuous improvement. Hardcoded state graphs and action protocols result in wasted resources on agents, as certain agents and/or prompts may not contribute significantly to the multi-agent system's task. Furthermore, users often are unaware of what configuration of agents will be best suited to solve a task.

In addition, the purpose of a multiagent system is for a system of experts to perform better than general LLMs. By breaking down tasks into specialized subtasks (ex., coder, reviewer, web scraper), the system is able to handle larger and more complicated problems. Currently, most agents utilize a general LLM (e.g., a coder agent might use GPT-4, yet Code LLAMA might yield better results). Additionally, as the system is utilized, the agents should continue to learn and specialize, which means they can give less emphasis to irrelevant knowledge. For example, a coder agent no longer needs to remember or utilize information about biology or history. Today, though, there exists no way to distill or prune models as they specialize, which would help increase performance by resulting in smaller yet just-as-accurate models for each agent.

Finally, the creation of multi-agent systems is heuristic-based and there exists no deterministic method to determine the optional group of agents, underlying models, system prompts, and connection network to achieve a user's task. This leads to unnecessary confusion and to wasted efforts when trying to decide between various configurations and similar underlying models.

### Agent Creation, Deployment, and Management in a Multi-Agent System With LLM-Based Agents

The techniques herein introduce mechanisms for the creation, deployment, and management of LLM-based agents able to interact with one another dynamically. In further aspects, the techniques herein also allow the multi-agent system to optimize itself over time.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device identifies capabilities of agents in a multi-agent system in which each agent uses a corresponding artificial intelligence model to perform sub-tasks of a task performed by the multi-agent system. The device obtains metrics regarding interactions between the agents. The device determines a change to the multi-agent system, based on the capabilities and metrics. The device provides an indication of the change to a user interface.

Operationally, the techniques provide for various functionalities in a multi-agent system, such as the following: 1.) self-optimization of the AI agents 2.) sparse activation/automatic model reduction as the AI agents specialize, and/or 3.) automated AI agent creation. The net result of this is a multi-agent AI system that is able to optimize itself over time while still providing insights to an administrator as to its operation.

With respect to self-optimization, the techniques herein introduce self-optimizing, multi-agent architectures that operate in two stages: monitoring and optimizing. This allows for online learning by the multi-agent system at a system/macro level. In addition, the techniques herein can take a fixed LLM or other AI-based agent system and develop a modified system that solves the same set of tasks with greater efficiency (e.g., by employing model pruning, using different LLM instances, different graphs, etc.). Further the techniques herein may suggest changes to the existing system and suggest new system architectures based on the specified optimization goals of the user. Such goals may include, but are not limited to, the number of API calls, the throughput of the system, or overall accuracy, among others.

During the monitoring stage, the system may operate by collecting metrics for the added utility of each agent towards the overall system task. For instance, the system may measure the contributions of each agent to the system “conversation” between the agents, the number of back-and-forth interactions between agents, the number of corrections/re-generations required, critical path analysis, etc. In addition, the system may also monitor the drift, bias, or errors of each agent when generating responses. Other metrics that the system may collect may relate to the resource consumption of the agents and the system as a whole (e.g., compute resources, accuracy, other costs, etc.).

Optimizations by the system can take different forms, depending on the optimization goals and the collected metrics such as any or all of the following:
Modification of individual agent prompts
   Ex.—Take on more tasks, focus on a different area, change response format, etc.
Modification of agent communication protocols
   Ex.—group, manager 1:1, sidelining some agents, modifying graph structure, etc.
Creation of new agents, removal of existing agents
   Ex.—Suggest smaller models that might work better
Based on efficiency, number of API calls, user input (response was incorrect), etc.
   Ex.—Coarse grained BERT, fine-grained GPT, etc.
   Ex.—Addition of a smaller BERT-based retriever or Elasticsearch to system

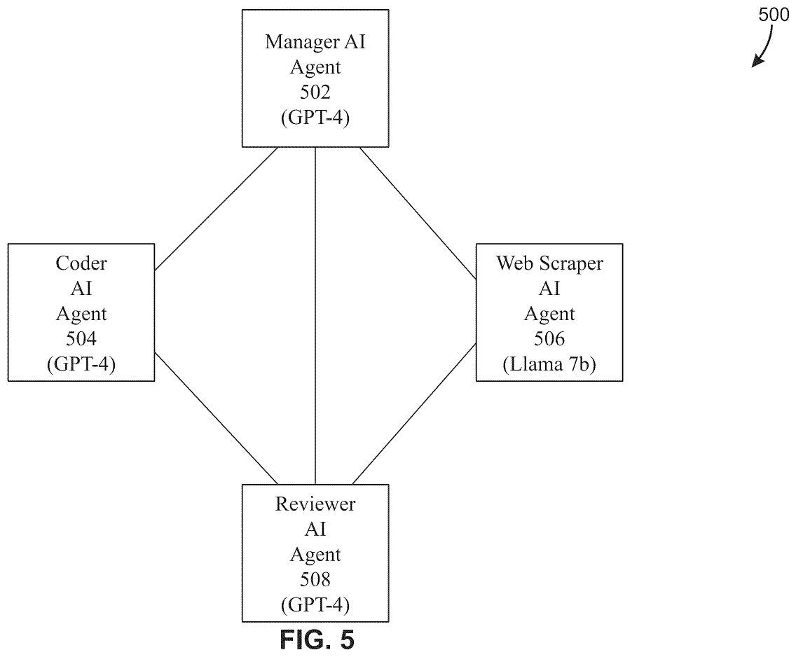

FIG. 5 illustrates an example architecture for a multi-agent system 500, according to various implementations. As shown, assume that there are four AI agents: a manager AI agent 502 that uses GPT-4 as its LLM model, a coder AI agent 504 that also uses GPT-4 as its LLM model, a web scraper AI agent 506 that instead uses Llama 7B as its model, and a reviewer AI agent 508 that uses GPT-4 as its LLM model. As would be appreciated, the number of agents shown is for illustrative purposes and a multi-agent system may include any number of such AI agents, as desired.

Each of the AI agents shown in FIG. 5 may have a dedicated role in performing the overall task given to multi-agent system 500. For instance, AI agent 502 may be responsible for overseeing the performance of the discreet sub-tasks performed by the other agents in multi-agent system 500, coder AI agent 504 may be responsible for generating any code needed to perform the task (e.g., to make an API call, etc.), web scraper AI agent 506 may be responsible for performing web searching regarding the task, and reviewer AI agent 508 may be responsible for reviewing the answers from the other agents in multi-agent system 500.

To accomplish the task given to multi-agent system 500, its constituent agents may interact with one another, such as by sending prompts or other instructions, as well as their outputs, between one another. For instance, AI agent 502 may communicate with coder AI agent 504, web scraper AI agent 506, and reviewer AI agent 508, depending on the task. Further, coder AI agent 504 and web scraper AI agent 506 may also communicate with reviewer AI agent 508, as needed to perform the task. Here, as noted above, the techniques herein may monitor these communications, as well as other performance metrics associated with the agents of multi-agent system 500 during a monitoring stage of operation.

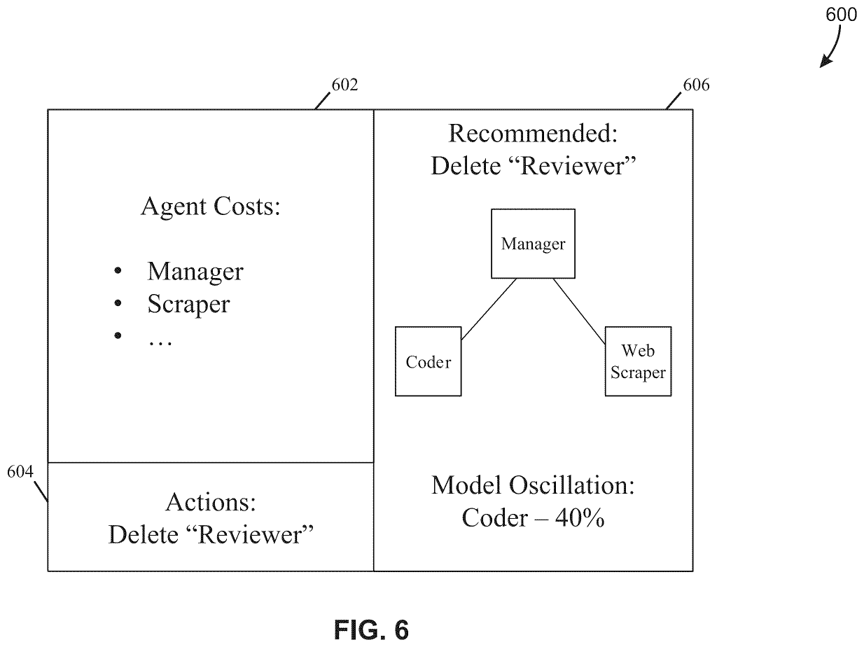

FIG. 6 illustrates an example dashboard 600 to manage a multi-agent system, in various implementations. As shown, the system may provide dashboard 600 to a user interface for review by an administrator or other interested party. Based on the metrics collected from the multi-agent system, dashboard 600 may display the costs 602 associated with the various agents of the multi-agent system (e.g., in terms of resource consumption or other costs).

According to various implementations, dashboard 600 may also generate and display a recommended set 604 of one or more actions, to optimize the multi-agent system. For instance, in the case of multi-agent system 500 in FIG. 5, the system may determine that the involvement of reviewer AI agent 508 is not necessary and adds to the overall latency when performing a task. Note that the recommended action(s) may also be a function of one or more optimization goals specified by a user via dashboard 600. For instance, while removing reviewer AI agent 508 from multi-agent system 500 may decrease the overall accuracy of the system when performing a certain type of task by a predicted amount, the predicted decrease in latency may be worth the slight decrease in accuracy.

In some cases, dashboard 600 may also display the adjusted multi-agent network 606, should the user opt to implement recommended set 604 of actions. Further, dashboard 600 may also present the predicted performance change(s), should the user opt to implement the recommended optimizations. For instance, dashboard 600 may indicate that there may be a 40% model oscillation associated with the coder AI agent.

In general, an aim of dashboard 600 is to present the monitoring analytics to the user in an explainable manner, such as:
Real-time information about the system's performance
Contributions of each agents, areas of concern/redundancy (e.g., how often the agent is used in the system, how often that agent is asked to refine or revise its answer, etc.)
History of how agents' prompts and roles have been modified
Cost-tracking of how overall cost/system task has varied
Recommended changes/staged changes for system modification
   Ex.—Agent X can be replaced with Agent Y that uses a smaller, domain-specific model

This also provides improved performance over time compared to the base system as it can quantify changes to the agent system directly.

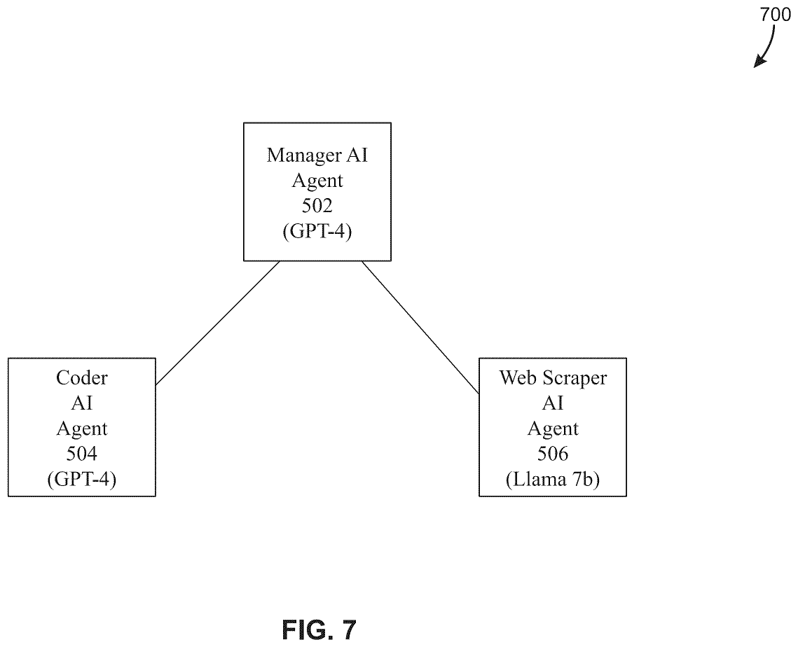

FIG. 7 illustrates an example optimization of the multi-agent system of FIG. 5, in various implementations. As shown, assume that the user of dashboard 600 has opted to implement the recommended optimizations, resulting in reviewer AI agent 508 being removed from multi-agent system 500, to form multi-agent system 700. In other words, the optimization in this instance may be simply to remove the ability of AI agent 502, coder AI agent 504, and/or web scraper AI agent 506 from communicating with reviewer AI agent 508. In other cases, the optimization may entail deleting reviewer AI agent 508 entirely.

In various implementations, another potential optimization that the system may identify over time relates to the specialization of the models over time. More specifically, LLM-based agents today are typically generalized. However, in multi-agent systems, this is often inefficient as different agents may only need to perform a specific subset of tasks.

To this end, the techniques herein may also monitor a given agent (either within, or independent of system). As a result, types of inputs and outputs of the multi-agent system can be captured and used to identify what can be pruned. In some implementations, the system may automatically perform model pruning in accordance with this approach, as the multi-agent system executes. In other cases, the system may indicate such model adjustments to an administrator via dashboard 600.

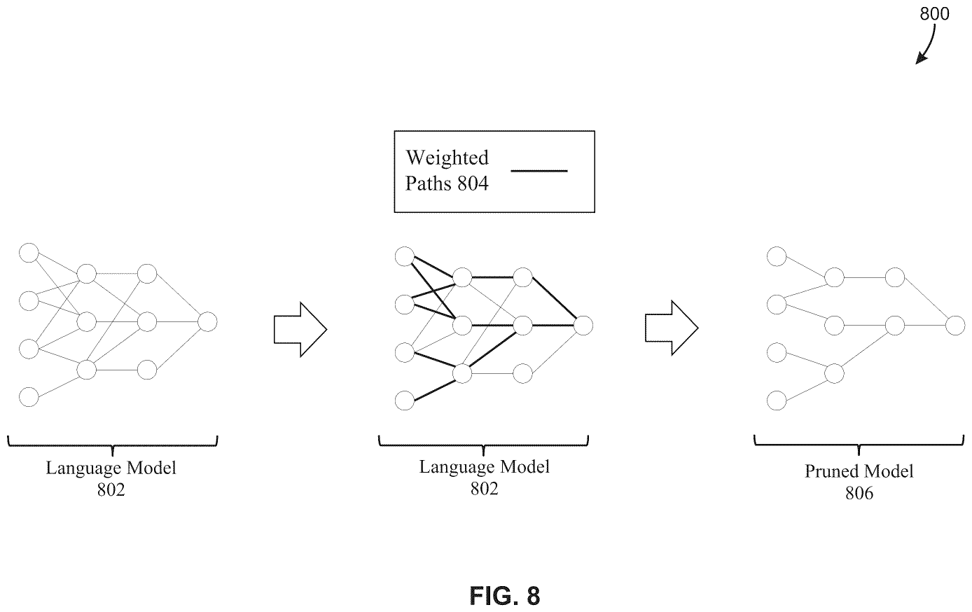

FIG. 8 illustrates an example 800 of model pruning to optimize the model of an AI agent, in various implementations. As shown, assume that there is a language model 802 used by a given AI agent in the multi-agent system. Such a model may initially be trained to have generalized knowledge about a large variety of subjects.

As the multi-agent system is used, it may also keep track of the topics and types of answers that it provides. For instance, assume that the multi-agent system is used primarily for assessing the operations of a computer network, despite language model 802 being trained on topics such as animals, sports, etc. In such a case, the system may identify weighted paths 804 within language model 802 that are unused by the multi-agent system.

One potential optimization for the multi-agent system would be to prune those weighted paths 804 from language model 802, to form pruned model 806. In doing so, pruned model 806 may be incapable of addressing tasks related to animals, sports, etc., but retain its ability to address sub-tasks related to computer networks. By pruning such paths within the neural network of language model 802, this also decreases the processing latency of pruned model 806 when addressing sub-tasks related to computer networks.

To perform the model optimizations, the system may utilize any suitable unlearning or other pruning approach such as teacher-student learning, online learning, and sparse activation to reduce model size while preserving performance. In addition, as the inputs and outputs of the model are monitored, the system could use model distillation to produce a smaller model using model distillation. This can be accomplished by using external libraries, in some cases.

In a further approach, the system could also leverage non-AI approaches such as network centralities in graphs to determine which weights/parts of a model are contributing least to its overall output and prune those. For example, most Mixture-of-Experts (MOE) based models learn to selectively activate the most relevant “expert pathways” in their neural network. The system can apply this in any language model to “extract” and preserve only the pathway that corresponds to the expert needed to resolve the agent's task, as illustrated in example 800.

Indeed, the distillation shown in example 800 over time of the underlying language model of a given agent leads to greater efficiency, less computational cost, and less risk of hallucinations (due to the removal of irrelevant “knowledge”).

The system may also present information about the specialization to dashboard 600 such as the reasoning for its proposed model changes, the reduction in model size(s), the chosen pathway(s), the expected change in agent performance, any direct modification of the agents' language model weights, the model optimization approach selected (e.g., distillation, unlearning, etc.), or any other information about the model changes.

According to various implementations, a further optimization of the multi-agent system may be to generate a new AI agent for inclusion in the system. Indeed, the creation of multi-agent systems today is largely based on heuristics. This leads to unnecessary confusion and wasted efforts trying to decide between configurations and underlying models. To address this, the techniques herein propose using a singular, managerial agent that serves as a user proxy in the multi-agent system.

A user defines their task, the APIs/tools (methods, keys) to which they have access, and their overall budget via dashboard 600. The managerial agent then, on-the-fly, determines which agents to “assemble” and the optimal set of tools and routing to provide them with in order to accomplish the task within the budget constraint. It also automatically assembles and launches this configuration, freeing the user from having to guesswork their way through the optimal configuration.

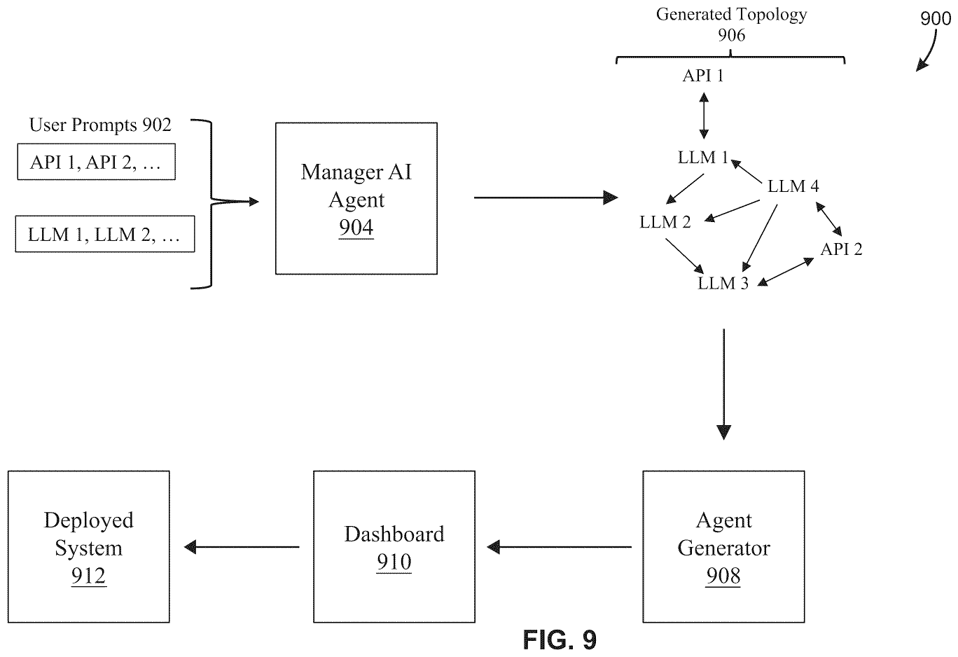

FIG. 9 illustrates an example 900 of the deployment of a new agent to a multi-agent system, in accordance with the techniques herein. As shown, given user prompts 902, manager AI agent 904 may construct a generated topology 906 for the AI agents needed to perform the indicated tasks. For instance, assume that the user specifies certain types of APIs, LLMs, etc. that should be used. In turn, manager AI agent 904 may generate a topology (i.e., generated topology 906) for the multi-agent system that is optimized in accordance with the specified goals of the user.

In turn, manager AI agent 904 may provide the generated topology 906 to an agent generator 908 that is configured to generate AI agents. In some implementations, agent generator 908 may also provide information to dashboard 910, to allow the user to review the proposed creation of one or more AI agents for the multi-agent system. This allows the user to approve or reject the changes. In other implementations, the system may automatically create the AI agent(s). In either case, the system may then configure the new AI agent(s) within the deployed system 912.

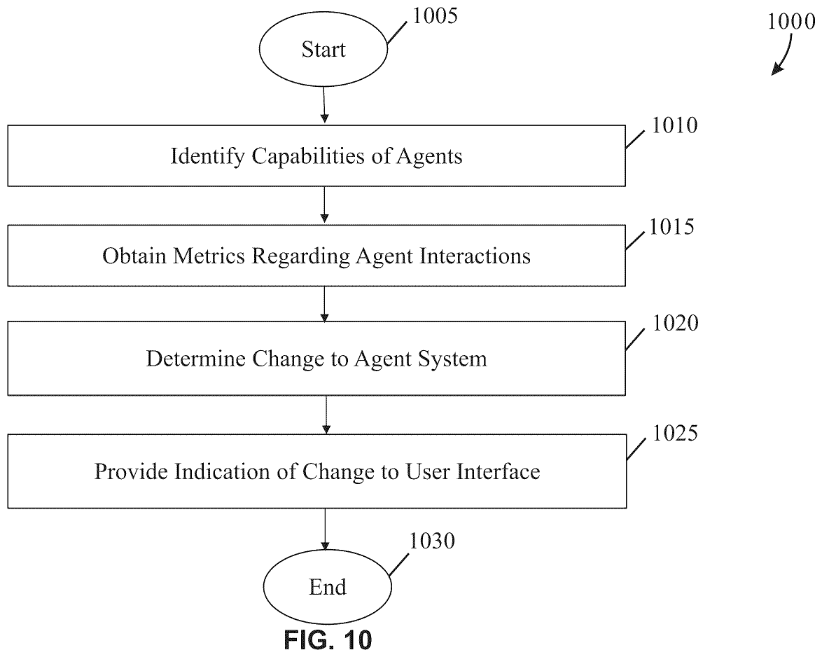

FIG. 10 illustrates an example of a simplified procedure for assessing the interactions of AI agents, in accordance with one or more implementations described herein. For example, a non-generic, specifically configured device (e.g., device 200), may perform procedure 1000 (e.g., a method) by executing stored instructions (e.g., AI process 248). The procedure 1000 may start at step 1005, and continues to step 1010, where, as described in greater detail above, the device (e.g., a controller, server, etc.) may identify capabilities of agents in a multi-agent system in which each agent uses a corresponding artificial intelligence model to perform sub-tasks of a task performed by the multi-agent system. In various implementations, one of the agents uses a corresponding artificial intelligence model that comprises a large language model (LLM).

At step 1015, as detailed above, the device may obtain metrics regarding interactions between the agents. In various implementations, the metrics regarding the interactions between the agents are indicative of how often a given agent is used in the multi-agent system or how often that agent is asked to refine or revise its answer.

At step 1020, the device may determine a change to the multi-agent system, based on the capabilities and metrics, as described in greater detail above. In one implementation, the change to the multi-agent system comprises generating a new agent for inclusion in the multi-agent system. In another implementation, the change to the multi-agent system comprises removing at least one of the agents from the multi-agent system. In a further implementation, the device determines the change based in part on one or more optimization goals specified via the user interface. In yet another implementation, the change to the multi-agent system comprises adjusting a particular artificial intelligence model associated with one of the agents. In such a case, adjusting the particular artificial intelligence model may entail removing a capability from that model.

At step 1025, as detailed above, the device may provide an indication of the change to a user interface. In some implementations, the device may implement the change, in response to an instruction to do so from the user interface. In other implementations, the device may automatically implement the change, prior to providing the indication of the change to the user interface.

Procedure 1000 may then end at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for agent creation, deployment, and management in a multi-agent system with LLM-based agents, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
identifying, by a device, capabilities of agents in a multi-agent system in which each agent uses a corresponding artificial intelligence model to perform sub-tasks of a task performed by the multi-agent system;
obtaining, by the device, metrics regarding interactions between the agents;
determining, by the device, a change to the multi-agent system, based on the capabilities and metrics; and
providing, by the device, an indication of the change to a user interface.

2. The method as in claim 1, further comprising:
implementing the change, in response to an instruction to do so from the user interface.

3. The method as in claim 1, further comprising:
automatically implementing the change, prior to providing the indication of the change to the user interface.

4. The method as in claim 1, wherein the change to the multi-agent system comprises generating a new agent for inclusion in the multi-agent system.

5. The method as in claim 1, wherein the change to the multi-agent system comprises removing at least one of the agents from the multi-agent system.

6. The method as in claim 1, wherein the device determines the change based in part on one or more optimization goals specified via the user interface.

7. The method as in claim 1, wherein the change to the multi-agent system comprises adjusting a particular artificial intelligence model associated with one of the agents.

8. The method as in claim 7, wherein adjusting the particular artificial intelligence model entails removing a capability from that model.

9. The method as in claim 1, wherein the metrics regarding the interactions between the agents are indicative of how often a given agent is used in the multi-agent system or how often that agent is asked to refine or revise its answer.

10. The method as in claim 1, wherein one of the agents uses a corresponding artificial intelligence model that comprises a large language model.

11. An apparatus, comprising:
one or more network interfaces;
a processor coupled to the one or more network interfaces and configured to execute one or more processes; and
a memory configured to store a process that is executable by the processor, the process when executed configured to:
identify capabilities of agents in a multi-agent system in which each agent uses a corresponding artificial intelligence model to perform sub-tasks of a task performed by the multi-agent system;
obtain metrics regarding interactions between the agents;
determine a change to the multi-agent system, based on the capabilities and metrics; and
provide an indication of the change to a user interface.

12. The apparatus as in claim 11, wherein the process when executed is further configured to:
implement the change, in response to an instruction to do so from the user interface.

13. The apparatus as in claim 11, wherein the process when executed is further configured to:
automatically implement the change, prior to providing the indication of the change to the user interface.

14. The apparatus as in claim 11, wherein the change to the multi-agent system comprises generating a new agent for inclusion in the multi-agent system.

15. The apparatus as in claim 11, wherein the change to the multi-agent system comprises removing at least one of the agents from the multi-agent system.

16. The apparatus as in claim 11, wherein the apparatus determines the change based in part on one or more optimization goals specified via the user interface.

17. The apparatus as in claim 11, wherein the change to the multi-agent system comprises adjusting a particular artificial intelligence model associated with one of the agents.

18. The apparatus as in claim 17, wherein the apparatus adjusts the particular artificial intelligence model entails removing a capability from that model.

19. The apparatus as in claim 11, wherein the metrics regarding the interactions between the agents are indicative of how often a given agent is used in the multi-agent system or how often that agent is asked to refine or revise its answer.

20. A tangible, non-transitory, computer-readable medium storing program instructions that cause a device to execute a process comprising:
identify, by the device, capabilities of agents in a multi-agent system in which each agent uses a corresponding artificial intelligence model to perform sub-tasks of a task performed by the multi-agent system;
obtain, by the device, metrics regarding interactions between the agents;
determine, by the device, a change to the multi-agent system, based on the capabilities and metrics; and
provide, by the device, an indication of the change to a user interface.
